(19) United States
(12) Patent Application Publication
(10) Pub. No.: US 2026/0122139 A1
(43) Pub. Date: Apr. 30, 2026

(54) STORAGE SYSTEM AND CONTROL METHOD THEREOF

(71) Applicant: Hitachi Vantara, Ltd., Yokohama-shi (JP)

(72) Inventors: Takayuki FUKATANI, Tokyo (JP); Nobuhiro YOKOI, Tokyo (JP)

(73) Assignee: Hitachi Vantara, Ltd., Yokohama-shi (JP)

(21) Appl. No.: 19/079,746

(22) Filed: Mar. 14, 2025

(30) Foreign Application Priority Data
Oct. 29, 2024 (JP) 2024-189933

(51) Int. Cl. H04L 67/141; H04L 43/0811; H04L 67/1097

(52) U.S. Cl. CPC H04L 67/141; H04L 43/0811; H04L 67/1097

(57) ABSTRACT

A storage system is provided with a network interface provided with a processor having a plurality of cores, each core processing a command involving communication with a target outside a node, and a controller that issues the command and causes the network interface to process the command, the network interface connects a plurality of first sessions between the network interface and the target, assigns the respective cores of the processor to the first sessions, manages the plurality of first sessions between the network interface and the target as one virtual second session, and processes the command issued from the controller by using the second session using any one of the plurality of first sessions.

### BACKGROUND OF THE INVENTION

### 1. Field of the Invention

The present invention relates to a storage system and a control method thereof, and is suitably applied to, for example, a storage system in which a smart network interface card (SmartNIC) is installed.

### 2. Description of Related Art

In recent years, a storage area network (SAN) has become widespread as a network form for connecting a storage system and a host server.

The SAN is a network configured with a combination of a switch and a network cable such as an optical fiber.

Such a SAN enables sharing of storage resources among a plurality of host servers.

The storage system connected to the host server via the SAN often performs remote replication for replicating data to a storage system at a remote site connected via a wide area network (WAN) in order to continue services at the time of disasters.

In the remote replication, the data is replicated in units of volumes provided by the storage system to the host.

Accordingly, even when a primary site is down, the services can be continued by using the data replicated to the remote site and stored in the volumes.

Here, the “volume” means a logical storage area (a logical volume).

The same applies to the following description.

In order to smoothly perform the remote replication in the volume whose capacity has been increased in recent years, a data transfer rate between a storage system serving as a remote replication source (hereinafter, appropriately referred to as an initiator storage system) and a storage system serving as a remote replication destination (hereinafter, appropriately referred to as a target storage system) is important.

In this regard, for example, Patent Literature 1 discloses a smart NIC utilization type storage system in which a smart NIC is installed and remote replication communication processing is offloaded to the smart NIC (hereinafter, referred to as the smart NIC utilization type storage system).

Here, the “smart NIC” means a network interface in which a processor and a memory are installed and a general-purpose operating system (OS) and an open source software (OSS) protocol server can be operated as they are.

By offloading block protocol processing from a controller of the storage system to the smart NIC, a load on the controller can be reduced and the performance of the storage system can be improved.

In the storage system in which the smart NIC is installed, after the smart NIC establishes a connection and a session with the target storage system at the remote site, data and control information are transferred between the smart NIC and the target storage system.

At this time, as a communication protocol between the smart NIC and the target storage system, an internet small computer system interface (iSCSI) protocol widely used in a general-purpose storage system can be used, and various storage systems can be used as the target storage system by using the iSCSI protocol.

### CITATION LIST

### Patent Literature

PTL 1: US2022/0400982

### SUMMARY OF THE INVENTION

However, in the smart NIC utilization type storage system in which the smart NIC is installed, there are the following two problems when the communication processing is offloaded to the smart NIC.

The first problem is that since communication between the smart NIC and the target storage system is normally performed by a single session for each target storage system and the session is processed by a single central processing unit (CPU) core in the smart NIC, the performance of the CPU core becomes a bottleneck in communication performance.

The CPU of the smart NIC usually includes a plurality of CPU cores, and can reduce overhead such as a lock conflict due to resource exclusion between the CPU cores by distributing and allocating sessions to be processed to the CPU cores.

Here, the “CPU core” means the number of processors incorporated in the CPU.

The CPU can perform the same number of processes as the number of CPU cores in parallel.

However, since the smart NIC establishes only one session for each target storage system and only one CPU core is responsible for the communication processing of the session, the communication performance depends on the performance of the CPU core responsible for the session even when other CPU cores are idle.

The second problem is that although it is conceivable to increase the number of sessions for each target storage system in order to solve the above problem, this method increases the amount of data in session information managed by both the smart NIC and the controller.

In particular, when a large number of smart NICs are installed in the storage system, the session information to be stored by the controller becomes enormous.

However, in the controller, the maximum number of sessions is determined in advance according to a memory capacity of the controller, and thus when the number of sessions for each target storage system is increased, the number of connectable target storage systems decreases in inverse proportion to the number of sessions.

The present invention has been made in view of the above points, and an object of the present invention is to propose a storage system and a control method thereof that are capable of improving communication performance while restraining the memory consumption of a controller.

In order to solve such problems, the present invention provides a storage system having a node and providing a storage area for storing data in a host device, the storage system includes a network interface provided with a processor having a plurality of cores, each core processing a command involving communication with a target outside the node; and a controller configured to control reading and writing of the data, issue the command involving the communication with the target, and cause the network interface to process the command, the network interface and the controller being provided at the node, in which the network interface connects a plurality of first sessions between the network interface and the target, and assigns the respective cores of the processor to the first sessions, manages the plurality of first sessions between the network interface and the target as one virtual second session, and processes the command involving the communication with the target, which is issued from the controller, by using the second session using any one of the plurality of first sessions.

Further, the present invention provides a control method of a storage system having a node and providing a storage area for storing data in a host device, the storage system includes, at the node, a network interface provided with a processor having a plurality of cores, each core processing a command involving communication with a target outside the node, and a controller configured to control reading and writing of the data, issue the command involving the communication with the target, and cause the network interface to process the command, the control method includes a first step of the network interface connecting a plurality of first sessions between the network interface and the target, allocating the respective cores of the processor to the first sessions, and managing the plurality of first sessions between the network interface and the target as one virtual second session; and a second step of the network interface processing the command involving the communication with the target, which is issued from the controller, by using the second session using any one of the plurality of first sessions.

According to the storage system and the control method thereof of the present invention, since the command from the controller to the network interface can be processed by the plurality of cores of the processor in the network interface, the performance of the cores of the processor can be prevented from becoming the bottleneck in communication performance.

Further, since the controller manages the plurality of first sessions as one virtual second session, it is possible to prevent an increase in the amount of session information to be managed on a memory by the controller.

According to the present invention, it is possible to achieve a storage system and a control method thereof that are capable of improving communication performance while restraining the memory consumption of a controller.

### BRIEF DESCRIPTION OF THE DRAWINGS

FIG. 1 is a block diagram for illustrating an outline of a first embodiment.

FIG. 2 is a block diagram illustrating an overall configuration of an information processing system according to the first embodiment.

FIG. 3 is a block diagram illustrating a configuration example of a host server.

FIG. 4 is a block diagram illustrating a configuration example of a management server.

FIG. 5 is a block diagram illustrating a configuration example of a controller of an initiator storage system.

FIG. 6 is a block diagram illustrating a configuration example of a front end interface of the initiator storage system.

FIG. 7 is a table showing a configuration example of a port management table.

FIG. 8 is a table showing a configuration example of a logical device management table.

FIG. 9 is a table showing a configuration example of a remote path management table.

FIG. 10 is a table showing a configuration example of a front end interface management table.

FIG. 11 is a table showing a configuration example of a session management table.

FIG. 12 is a table showing a configuration example of a virtual session management table.

FIG. 13 is a table illustrating a command format of an IO command.

FIG. 14 is a sequence diagram illustrating a flow of session establishment processing.

FIG. 15 is a sequence diagram illustrating a flow of write IO command processing.

FIG. 16 is a sequence diagram illustrating a flow of abort command processing.

FIG. 17 is a sequence diagram illustrating a flow of session disconnect processing.

FIG. 18 is a sequence diagram illustrating a flow of session monitoring processing.

FIG. 19 is a block diagram for illustrating an outline of a second embodiment.

FIG. 20 is a block diagram for illustrating an outline of a third embodiment.

### DESCRIPTION OF EMBODIMENTS

Hereinafter, embodiments of the present invention will be described in detail with reference to the drawings.

Note that the embodiments described below do not limit the scope of the claims of the present invention, and all of elements described in the embodiments are not necessarily required to solve the problems of the present invention.

Hereinafter, for the sake of convenience, description will be made by being divided into a plurality of sections or the embodiments as needed, but unless otherwise stated, those are not unrelated to one another, and one is a modification, details, supplementary description, and the like of a part or all of the other ones.

Hereinafter, when referring to the number or the like of elements (including the number, a numeric value, an amount, a range, or the like), the number of elements is not limited to a specific number, and may be the specific number or more or the specific number or less, unless otherwise specified or except a case in which the number is apparently limited to a specific number in principle.

### (1) First Embodiment

### (1-1) Outline of Present Embodiment

In the present embodiment, as an initiator storage system, a smart NIC utilization type storage system is assumed in which a smart NIC is installed and communication processing is offloaded to the smart NIC from a controller of a storage system controlling remote replication.

Further, in the present embodiment, it is assumed that a controller of such an initiator storage system connects to one target storage system by one session by using a communication protocol such as iSCSI, and performs the remote replication to the target storage system.

At this time, the smart NIC of the initiator storage system internally establishes a plurality of iSCSI sessions (hereinafter, referred to as real sessions) between the smart NIC and the target storage system and uses the plurality of iSCSI sessions for data communication.

Accordingly, a load can be distributed among CPU cores in the smart NIC, and the communication performance can be improved.

Further, regarding the controller, by virtualizing the plurality of real sessions and presenting the plurality of real sessions as one session, session information to be managed by the controller is reduced and the resource consumption of the controller is restrained.

The following description of the smart NIC can also be applied to an interface device having a programmable logic circuit configuration, such as a field programmable gate array (FPGA), in addition to an interface device whose functions can be programmed by software to be executed by a processor.

The FPGA may include a logic circuit that achieves functions to be implemented by programs and a cache memory to be used in an operation.

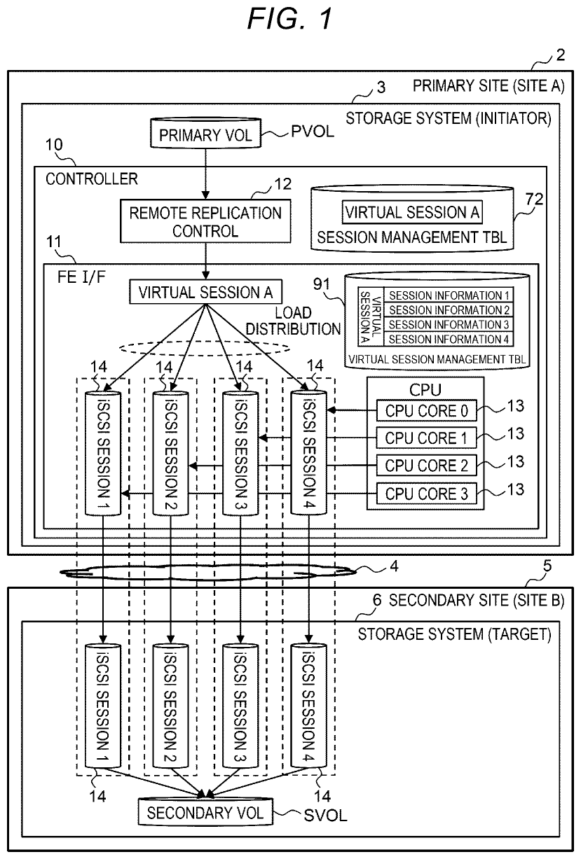

FIG. 1 illustrates an outline of a case in which a storage system 3 provided in a primary site 2 (the “site A” in FIG. 1) performs the remote replication to a storage system 6 provided in a secondary site 5 (the “site B” in FIG. 1) via a network 4 such as a WAN by using the above communication method.

A controller 10 of the storage system (the initiator storage system) 3 provided in the primary site 2 is equipped with a front end interface 11 including the smart NICs.

Further, the front end interface 11 establishes sessions between the front end interface 11 and the storage system (the target storage system) 6 provided in the secondary site 5, and transfers data such as replication data and control information.

Further, a remote replication control program 12 implemented in the controller 10 of the initiator storage system 3 replicates data of a volume (hereinafter, referred to as a primary volume) PVOL in the initiator storage system 3 to a specific volume (hereinafter, referred to as a secondary volume) SVOL provided in the target storage system 6, and reflects subsequent updates on the primary volume PVOL to the secondary volume SVOL.

The controller 10 of the initiator storage system 3 requests the front end interface 11 to establish a communication path with the target storage system 6 at the start of the remote replication.

Then, the front end interface 11 that has received the request transmits, for example, a transmission control protocol/Internet protocol (TCP/IP) connection request to the target storage system 6, thereby establishing a TCP/IP connection with the target storage system 6.

After that, the front end interface 11 establishes the real sessions between the front end interface 11 and the target storage system 6 in order to perform data transfer on the TCP/IP connection.

At this time, the front end interface 11 establishes the same number of TCP/IP connections as the number of CPU cores 13 assigned to a port used for the session and real sessions 14 on the TCP/IP connections.

Further, the front end interface 11 assigns one real session 14 among the distinct real sessions 14 established as described above to each CPU core 13, and then evenly distributes processing for a command such as an IO command across all CPU cores 13.

Accordingly, load distribution between the CPU cores 13 can be achieved.

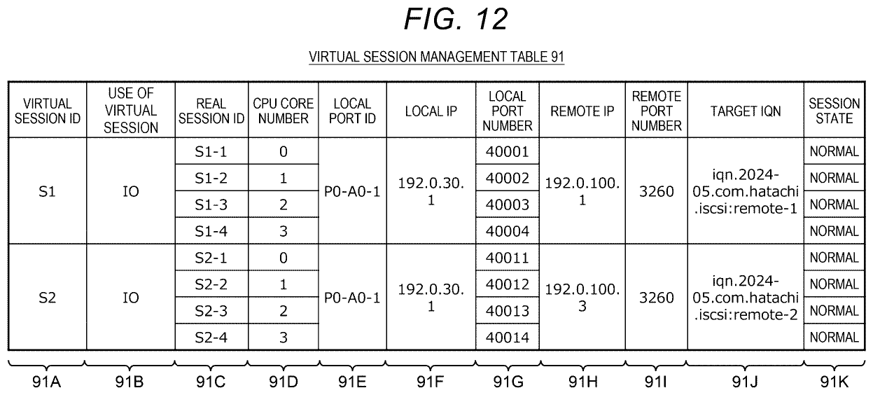

The front end interface 11 manages session information on the respective real sessions 14 by using a virtual session management table 91 to be described later with reference to FIG. 12, and virtually presents the plurality of real sessions 14 as one session to the controller 10.

That is, the front end interface 11 notifies the controller 10 of the session information on the plurality of real sessions 14 as session information on the above virtual one session (hereinafter, referred to as a virtual session).

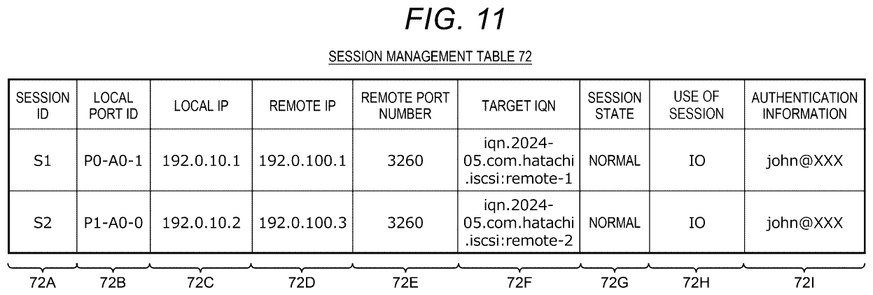

Then, the controller 10 registers and manages the session information on the virtual session provided from the front end interface 11 in a session management table 72 to be described later with reference to FIG. 11.

Accordingly, it is possible to restrain the total number of pieces of session information to be managed by the session management table 72 stored in the controller 10.

By the above method, in the remote replication of the smart NIC utilization type storage system (the initiator storage system 3), it is possible to improve the communication performance at the time of the data transfer while distributing the load between the CPU cores 13 of the front end interface 11.

In addition, even when the number of sessions for the target storage system 6 is increased, the resource consumption of the controller 10 of the initiator storage system 3 can be made equal to that in a case in which the number of sessions is one, and session can be performed with the same number of target storage systems as in the related art when viewed from the controller 10.

Hereinafter, an information processing system according to the present embodiment to which such a method is applied will be described.

In the following, a case in which a smart NIC is applied as the front end interface 11 is exemplified, but it is merely one example embodiment.

For example, the present invention can also be applied to a storage system in which no smart NIC is installed and the controller 10 performs a control process related to communication with other storage systems.

Further, in the above description, the case has been described in which the present invention is applied when the remote replication is performed from the storage system 3 of the primary site 2 to the storage system 6 of the secondary site 5, but the present invention is not limited thereto, and the present invention can also be applied when the remote replication is performed from the storage system 6 of the secondary site 5 to the storage system 3 of the primary site 2.

### (1-2) Configuration of Information Processing System According to Present Embodiment

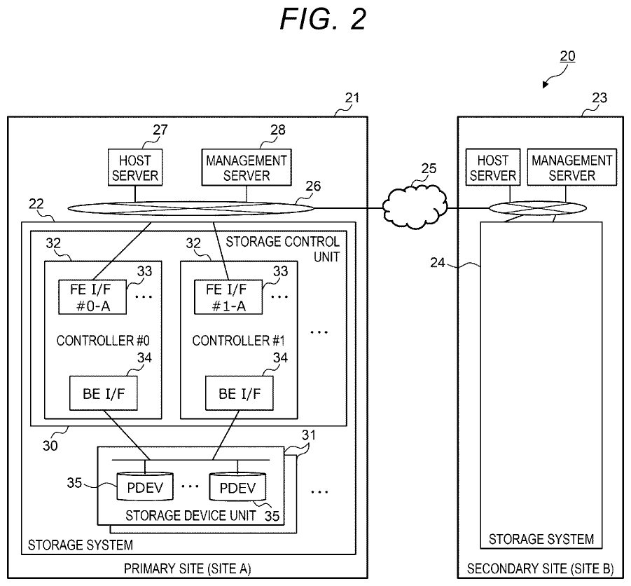

In FIG. 2, the reference numeral 20 denotes an information processing system according to the present embodiment as a whole.

In the information processing system 20, a storage system 22 provided in a primary site 21 and a storage system 24 provided in a secondary site 23 are connected via a network 25 such as a WAN, and can communicate with each other.

Here, it is assumed that the storage system 22 of the primary site 21 and the storage system 24 of the secondary site 23 have the same configuration, and the common configuration will be described as the configuration of the storage system 22.

As the storage system 24 of the secondary site 23, a storage system having a configuration different from that of the storage system 22 of the primary site 21 may be used, and the description thereof is omitted for simplification.

The storage system 22 of the primary site 21 is connected to a host server 27 and a management server 28 via a network 26 such as a local area network (LAN) or a WAN.

The host server 27 is a host device that reads/writes data from or to the storage system 22, and issues an input/output (IO) command (a read command and a write command) to the storage system 22.

The host server 27 transmits the IO command in units of blocks to the storage system 22 according to a block protocol.

Here, the “block protocol” is a data communication protocol for reading and writing data in units of fixed-length blocks.

In a storage system that provides a block protocol, a physical storage area is divided into a plurality of logical volumes (LU: logical unit) and is managed, and a data access service is provided to a host server in units of blocks defined in the logical volumes and having a predetermined size.

Further, the management server 28 is a management device to be used by a user or an operator to control or monitor the storage system 22, and includes a user interface such as a graphical user interface (GUI) and a command line interface (CLI).

The user or the operator can use this user interface to provide various instructions to the storage system 22 or to monitor the storage system 22.

The storage system 22 includes one or more storage control units (compute nodes) 30 and one or more storage device units (drive nodes) 31.

The storage control unit 30 includes one or more controllers 32.

In order to improve the availability of the storage system 22, a dedicated power supply may be prepared for each controller 32, and power may be supplied from the dedicated power supply to each controller 32.

Further, a plurality of storage control units 30 may be provided, and the controllers 32 may be connected via a host channel adaptor (HCA) network.

The controller 32 provides a storage area provided by a storage device 35 in the storage device unit 31 to be described later to the host server 27 as a logical volume for reading and writing data, and has a function of processing a data reading and writing request from the host server 27 with respect to the logical volume.

Further, the controller 32 has a function of performing remote replication for replicating such a volume to the storage system 24 of the secondary site 23.

The controller 32 includes one or more front end interfaces 33 and one or more backend interfaces 34, performs communication between either the host server 27 or the management server 28, and the storage system 24 of the secondary site 23 via the network 26 by the front end interface 33, and performs communication with the storage device unit 31 by the backend interface 34.

The storage device unit 31 includes a plurality of physical storage devices (PDEV: physical device) 35.

Such a storage device 35 is implemented by a nonvolatile large-capacity storage device such as a hard disk device and a solid state drive (SSD).

Different types of storage devices can be applied as the storage devices 35 in the same storage device unit 31.

Further, a redundant array of inexpensive disks (RAID) group may be configured with a plurality of storage devices 35 of the same type.

Data is stored in the RAID group according to a predetermined RAID level.

Next, specific configurations of the host server 27, the management server 28, and the storage system 22 will be described.

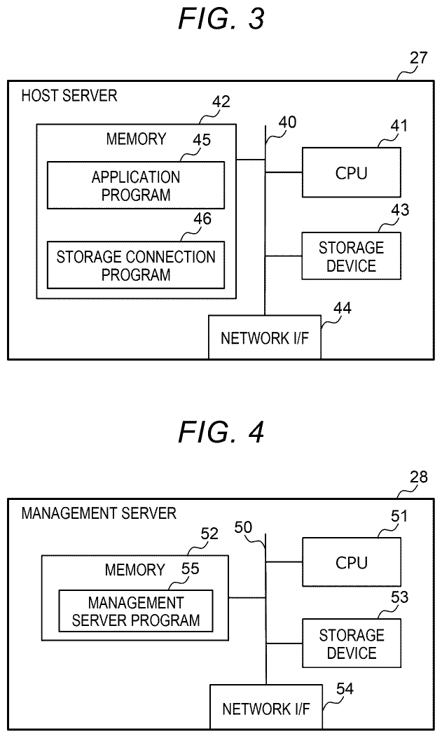

FIG. 3 illustrates a configuration example of the host server 27.

As illustrated in FIG. 3, the host server 27 includes a CPU 41, a memory 42, a storage device 43, and a network interface 44 that are connected to one another via an internal bus 40 such as a peripheral component interconnect-express (PCIe) bus.

The CPU 41 is a processor that performs operation control for the entire host server 27.

The memory 42 is implemented by a volatile semiconductor memory such as a random access memory (RAM), and is used as a working memory of the CPU 41.

The storage device 43 is implemented by a nonvolatile large-capacity storage device such as a hard disk device and an SSD, and stores various types of programs and data that requires long-term storage.

The network interface 44 is an interface device for communicating with the storage system 22 and the management server 28.

In the present embodiment, the memory 42 of the host server 27 stores an application program 45 and a storage connection program 46 that are read from the storage device 43 when the host server 27 is started or when necessary.

The application program 45 is a program that has a function of reading and writing data from and to a logical volume provided by the storage system 22 via the storage connection program 46.

The storage connection program 46 is a program that has a function of receiving various types of requests such as an input/output (IO) request from the application program 45, and reading and writing data from and to the storage system 22.

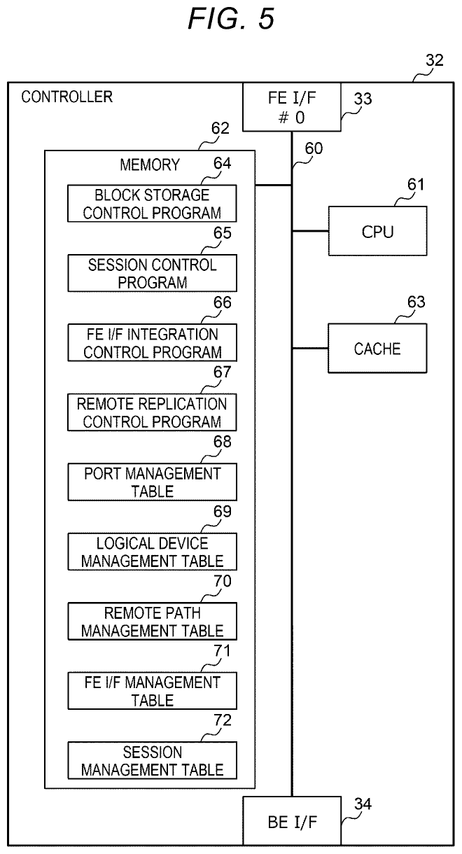

On the other hand, FIG. 4 illustrates a configuration example of the management server 28.

As illustrated in FIG. 4, the management server 28 also includes a CPU 51, a memory 52, a storage device 53, and a network interface 54 that are connected to one another via an internal bus 50 such as a PCIe bus.

Since the CPU 51, the memory 52, the storage device 53, and the network interface 54 are devices having the same configurations and functions as the CPU 41, the memory 42, the storage device 43, and the network interface 44 of the host server 27, respectively, the description thereof will be omitted here.

A management server program 55 is stored in the memory 52 of the management server 28.

The management server program 55 is a program that has a function of providing a user interface such as a GUI, a CLI, or a representational state transfer (REST) ful application programming interface (API), and provides a function of the user or the operator controlling or monitoring the storage system 22.

When a control instruction or a monitoring instruction to the storage system 22 is received from the user or the operator, the management server program 55 performs control or management by communicating with the storage system 22.

On the other hand, FIG. 5 illustrates a configuration example of the controller 32 of the storage system 22.

The controller 32 includes the front end interface 33, the backend interface 34, a CPU 61, a memory 62, and a cache 63 that are connected to one another via an internal bus 60 such as a PCIe bus.

The front end interface 33 is a programmable network interface, and is implemented by a smart NIC or the like.

In the present embodiment, block protocol processing is executed on the front end interface 33.

The backend interface 34 is an interface device for the controller 32 to communicate with the storage device unit 31 (FIG. 2).

The backend interface 34 stores the data written to the logical volume by the host server 27 to the storage device 35 (FIG. 2) in the storage device unit 31 associated with the logical volume.

Since the CPU 61 and the memory 62 have the same configurations and functions as the CPU 41 and the memory 42 of the host server 27, respectively, the description thereof will be omitted here.

The cache 63 is implemented by a volatile semiconductor memory or the like, and is used to temporarily store data to be written which is provided from the host server 27 or the front end interface 33, or data read from the storage device unit 31.

In the present embodiment, the memory 62 stores a block storage control program 64, a session control program 65, a front end interface integration control program 66, a remote replication control program 67, a port management table 68, a logical device management table 69, a remote path management table 70, a front end interface management table 71, and the session management table 72.

However, these programs and management tables may be stored in the storage device unit 31 (FIG. 2).

The block storage control program 64 is a program that has a function of combining a plurality of logical devices (LDEVs), which are logical storage areas of a predetermined size associated with physical storage areas provided by the respective storage device units 31, to configure a logical volume, and providing the configured logical volume to the front end interface 33.

The front end interface 33 can designate a logical volume and access any logical device.

Accordingly, the front end interface 33 can use the logical device as a storage destination of data stored in the logical volume provided to the host server 27.

The data stored in the logical device is stored in the corresponding storage device 35 in the storage device unit 31 associated with the logical device by the backend interface 34.

The session control program 65 is a program that has a function of controlling sessions between the host server 27 and the front end interface 33.

Further, the session control program 65 also has a function of instructing the front end interface 33 to perform connect and disconnect of the session, and information acquisition with the target storage system 24 (FIG. 2), according to an instruction from the remote replication control program 67 to be described later.

The front end interface integration control program 66 is a program that has a function of controlling all the front end interfaces 33 in the controller 32 in which the front end interface integration control program 66 is implemented (hereinafter, referred to as the own-controller 32).

The front end interface integration control program 66 turns on a power supply of the necessary front end interface 33 to activate the front end interface 33, and initializes the front end interface 33 through the internal bus, thereby enabling the reception of data access from the host server 27.

The remote replication control program 67 is a program that has a function of controlling remote replication of data from the storage system 22 in which the own-controller 32 exists to the storage system 24 of the secondary site 23.

Details of the port management table 68, the logical device management table 69, the remote path management table 70, the front end interface management table 71, and the session management table 72 will be described later.

All the management tables stored by the controllers 32 in the storage system 22 are updated in synchronization with each other, and all the controllers 32 execute various control processes based on information stored in management tables having the same contents.

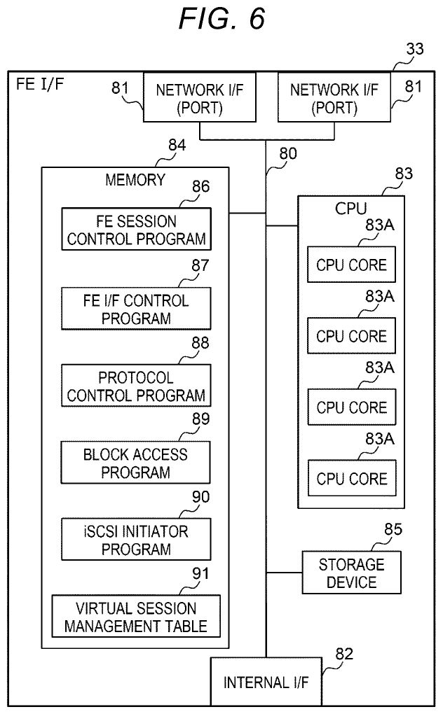

FIG. 6 illustrates a configuration example of the front end interface 33 according to the present embodiment.

As illustrated in FIG. 6, the front end interface 33 includes one or more network interfaces 81, an internal interface 82, a CPU 83, a memory 84, and a storage device 85 that are connected to one another via an internal bus 80 such as a PCIe bus.

The network interface 81 is an interface device for communicating with the host server 27 and the storage system 24 of the secondary site 23 (FIG. 2), and is implemented by, for example, a physical port.

Therefore, hereinafter, the network interface 81 is referred to as the port 81.

A unique Internet Protocol (IP) address is set for the port 81.

The IP address is an identifier on the network, and the host server 27 and the storage system 24 of the secondary site 23 communicate with the front end interface 33 by using the IP address set for the port 81.

The internal interface 82 is a device that serves as an interface when the CPU 83 communicates with other devices or the like in the own-controller 32 via the internal bus 80.

The CPU 83 is a processor that performs operation control for the entire front end interface 33.

In the present embodiment, the CPU 83 of the front end interface 33 includes one or more CPU cores 83A.

Each CPU core 83A can operate as an independent CPU, and processes various commands involving communication with the target storage system 24, for example.

The memory 84 is implemented by, for example, a semiconductor memory such as a RAM, and is used as a working memory of the CPU cores 83A.

Further, the storage device 85 is implemented by, for example, a nonvolatile semiconductor memory such as a flash memory, and is used to store various programs and data necessary for the operation of the front end interface 33.

In the present embodiment, the memory 84 of the front end interface 33 stores a front end session control program 86, a front end interface control program 87, a protocol control program 88, a block access program 89, an iSCSI initiator program 90, and the virtual session management table 91.

Details of the virtual session management table 91 will be described later.

The front end session control program 86 is a program that has a function of establishing a connection or a session for communication between the storage system 22 and the host server 27, the front end interface (hereinafter, referred to as the own-front end interface) 33 in which the front end session control program 86 is implemented exists in the storage system (hereinafter, referred to as the own-storage system) 22, or for communication between the own-storage system 22 and the storage system 24 of the secondary site 23.

In the present embodiment, the TCP/IP connection is assumed as the type of the connection, and the iSCSI session is assumed as the session.

Specifically, the front end session control program 86 constitutes a TCP port for a Listen service that receives a connect request from the host server 27.

Then, when receiving the connect request for the Listen service, the front end session control program 86 establishes the TCP/IP connection with the host server 27.

Thereafter, the front end session control program 86 receives a session request from the host server 27 and establishes a session with the host server 27.

In addition, for each port 81 of the own-front end interface 33, the front end session control program 86 requests the storage system 24 of the secondary site 23 to establish a connection request, and establishes a connection with the storage system 24.

Thereafter, the front end session control program 86 requests the storage system 24 to establish a session, and establishes a session with the storage system 24.

The front end interface control program 87 is an operating system (OS) of the own-front end interface 33, and is a program that has a function of communicating with the own-controller 32 and performing the initialization of the own-front end interface 33, resource management, failure management, task scheduling, and the like.

The front end interface control program 87 synchronizes various management tables (including the virtual session management table 91) stored in the memory 84 with the corresponding management tables stored in the memory 62 (FIG. 5) of the own-controller 32 in cooperation with the front end interface integration control program 66 (FIG. 5) of the own-controller 32.

The protocol control program 88 is a program that has a function of processing a block access protocol received from the host server 27 and converting the block access protocol into a block access command request to the own-controller 32.

Further, the block access program 89 also communicates with the own-controller 32, and reads and writes data from and to the logical device constituting the logical volume.

The iSCSI initiator program 90 is a program that has a function of connecting to an iSCSI target of a storage system different from the storage system such as the storage system 24 of the secondary site 23, and reading and writing data from and to a logical volume provided by the iSCSI target.

Each CPU core 83A of the CPU 83 can independently read and write data from and to the logical volume by independently executing the iSCSI initiator program 90.

### (1-3) Configurations of Various Management Tables

Next, configurations of various management tables stored by the controller 32 and the front end interface 33 of the storage system 22 will be described.

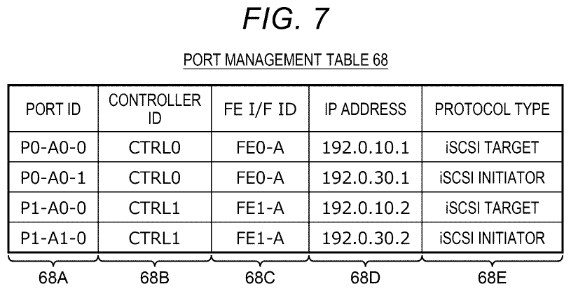

FIG. 7 shows a configuration of the port management table 68 stored in the memory 62 (FIG. 5) of the controller 32.

The port management table 68 is a table used by the controller 32 to manage the ports 81 (FIG. 6) held by the respective front end interfaces 33 in the own-storage system 22.

As shown in FIG. 7, the port management table 68 includes a port ID field 68A, a controller ID field 68B, a front end interface ID field 68C, an IP address field 68D, and a protocol type field 68E.

In the port management table 68, one record (row) corresponds to one port existing in the own-storage system 22.

An identifier (a port ID) unique to the corresponding port 81 in the own-storage system 22 assigned to the port 81 is stored in the port ID field 68A.

An identifier (a front end interface ID) unique to the front end interface 33 including the port 81 in the own-storage system 22 assigned to the front end interface 33 is stored in the front end interface ID field 68C.

Further, an identifier (a controller ID) unique to the own-controller 32 in which the front end interface 33 is implemented in the own-storage system 22 assigned to the own-controller 32 is stored in the controller ID field 68B, and the IP address set for the corresponding port 81 is stored in the IP address field 68D.

Further, the protocol type set for the port 81 is stored in the protocol type field 68E.

The protocol type also includes information on the “target” that is an access destination of data from another storage system or the “initiator” that is an access destination for reading and writing data from and to another storage system.

Examples of such a protocol type include the “iSCSI target”, an “iSCSI initiator”, an “NVMe/TCP target”, and an “NVMe/TCP initiator”.

Therefore, in the case of the example of FIG. 7, for example, it is indicated that the port 81 to which the port ID of “P0-A0-0” is assigned is a port provided in the front end interface 33 of “FE0-A” installed in the controller 32 of “CTRL0”, the IP address of “192.0.10.1” is assigned thereto, and the protocol type thereof is the “iSCSI target”.

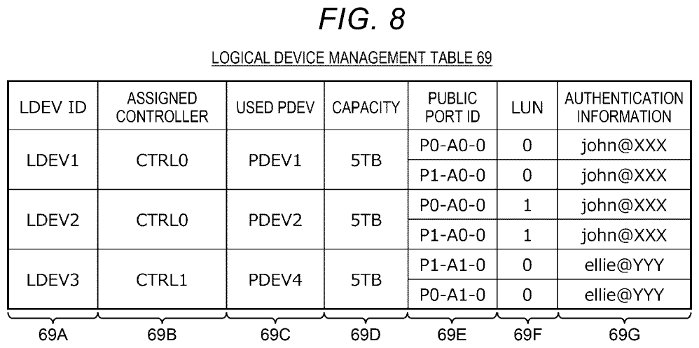

FIG. 8 shows a configuration of the logical device management table 69 stored in the memory 62 of the controller 32.

The logical device management table 69 is a table used by the controller 32 to manage the logical devices defined in the own-storage system 22.

Each logical device is assigned with the controller 32 that is responsible for reading and writing of data from and to the logical device, and each controller 32 refers to the logical device management table 69 to read and write data from and to the logical device assigned to the controller 32.

The controller 32 that is responsible for the logical device can be changed by updating the logical device management table 69.

As shown in FIG. 8, the logical device management table 69 includes a logical device ID field 69A, an assigned controller field 69B, a used physical device field 69C, a capacity field 69D, a public port ID field 69E, a LUN field 69F, and an authentication information field 69G.

In the logical device management table 69, one record corresponds to one logical device existing in the own-storage system 22.

An identifier (an LDEV ID) unique to the corresponding logical device in the own-storage system 22 assigned to the logical device is stored in the logical device ID field 69, and the identifier (the controller ID) of the controller 32 that is responsible for the reading and writing of data from and to the logical device is stored in the assigned controller field 69B.

An identifier (a PDEV ID) unique to a physical storage area of a predetermined size associated with the corresponding logical device (which is a physical storage area provided by the corresponding storage device, and hereinafter referred to as a physical device) in the own-storage system 22 assigned to the storage device is stored in the used physical device field 69C.

Further, the capacity of the logical device is stored in the capacity field 69D, and the port ID of the port 81 that publishes the logical device to the host server 27 is stored in the public port ID field 69E.

A plurality of ports 81 may exist for one logical device.

An identifier (an LUN) unique to a logical volume configured with the logical device in the own-storage system 22 assigned to the logical volume is stored in the LUN field 69F.

Further, authentication information such as an account and a password when the host server 27 accesses the corresponding logical device is stored in the authentication information field 69G.

Therefore, in the case of the example of FIG. 8, it is indicated that the logical device of “LDEV1” is associated with the physical device of “PDEV1” and the capacity thereof is “5 TB”.

FIG. 8 also shows that the logical device is associated with the controller 32 of “CTRL0” as an assigned controller and constitutes the logical volume of the LUN “0”.

Further, FIG. 8 also shows that the logical device is published to the host server 27 via the two ports 81 of “P0-A0-0” and “P1-A0-0”, and the authentication information is “john@ XXX”.

Although FIG. 8 shows the case in which one storage device is associated with one logical volume, it is merely an example.

For example, as in the case of a thin provisioning function, it is also possible to create a capacity pool having a large capacity by using one or more physical devices, virtually cut out a storage area by a necessary capacity, and use the storage area as a logical device.

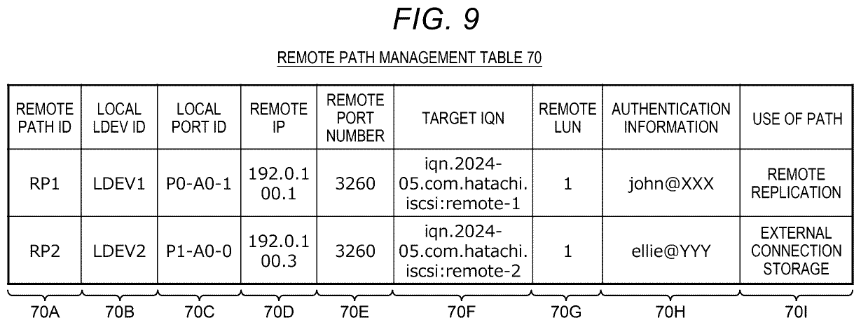

FIG. 9 shows a configuration of the remote path management table 70 stored in the memory 62 of the controller 32.

The remote path management table 70 is a table used by the controller 32 to manage a path (hereinafter, referred to as a remote path) set between the controller 32 and the storage system 24 (FIG. 2) of the secondary site 23 (FIG. 2).

The remote path is set by the user via the interface of the management server 28 (FIG. 2), and information thereon is stored in the remote path management table 70.

Then, the controller 32 of the storage system 22 of the primary site 21 (FIG. 2) refers to the information stored in the remote path management table 70, and transmits various control information and data stored in the logical device as a remote replication source to the storage system 24 of the secondary site 23.

As shown in FIG. 9, the remote path management table 70 includes a remote path ID field 70A, a local LDEV ID field 70B, a local port ID field 70C, a remote IP field 70D, a remote port number field 70E, a target IQN field 70F, a remote LUN field 70G, an authentication information field 70H, and the use of path field 70I.

In the remote path management table 70, one record corresponds to one remote path set between the own-storage system 22 and the storage system 24 as a remote replication destination.

An identifier (a remote path ID) unique to the corresponding remote path in the own-storage system 22 assigned to the remote path is stored in the remote path ID field 70A.

Further, the LDEV ID of the logical device on a local side (the side of the own-storage system 22, the same applies hereinafter) as a remote replication target is stored in the local LDEV ID field 70B, and the port ID of the port 81 (FIG. 6) on the local side that is used for the remote replication is stored in the local port ID field 70C.

The IP address set for the port on a remote side (the side of the storage system 24 as the remote replication destination, the same applies hereinafter) to which the remote path is connected is stored in the remote IP field 70D, and a port number on a communication protocol of the storage system 24 on the remote side is stored in the remote port number field 70E.

Here, the “port number” means a number for identifying a program (service) used by a computer for communication in a communication protocol.

Further, an identification name (IQN: iSCSI Qualified Name) of an iSCSI service at the remote replication destination is stored in the target IQN field 70F, and an identifier in a corresponding IQN for accessing the logical volume as the remote replication destination is stored in the remote LUN field 70G. Further, authentication information such as an account and a password for accessing the logical volume as the remote replication destination is stored in the authentication information field 70H, and the use of a remote connection is stored in the use of the path field 70I.

Examples of such use include external storage access, hierarchical control, and the like in addition to the remote replication.

The use of path is also set by the user via the user interface of the management server 28 (FIG. 2).

Therefore, in the case of the example of FIG. 9, it is indicated that the remote path of “RP1” is a path used for performing the “remote replication” of data stored in the logical device of “LDEV1” on the local side, and is a path connecting the port 81 of “P0-A0-1” on the local side and the port on the remote side to which the IP address of “192.0.100.1” is assigned and the port number of “3260” is assigned.

FIG. 9 also shows that the LUN of the logical volume as the remote replication destination on the remote side is “1”, and the authentication information for accessing the logical volume is the “john@XXX”.

Further, FIG. 9 also shows that the IQN of the iSCSI target is “inq.2024-05.com.hatachi.iscsi: remote-2”.

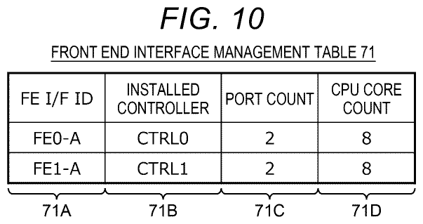

FIG. 10 shows a configuration of the front end interface management table 71 stored in the memory 62 (FIG. 5) of the controller 32.

The front end interface management table 71 is a table used by the controller 32 to manage the front end interface 33 (FIG. 6) existing in the own-storage system 22.

As shown in FIG. 10, the front end interface management table 71 includes a front end interface ID field 71A, an installed controller field 71B, a port count field 71C, and a CPU core count field 71D.

In the front end interface management table 71, one record corresponds to one front end interface 33 existing in the own-storage system 22.

The identifier (the front end interface ID) unique to the corresponding front end interface 33 in the own-storage system 22 assigned to the front end interface 33 is stored in the front end interface ID field 71A.

The controller ID of the controller 32 in which the front end interface 33 is installed is stored in the installed controller field 71B, and the number of ports 81 of the corresponding front end interface 33 is stored in the port count field 71C.

Further, the number of CPU cores 83A (FIG. 6) of the CPU 83 (FIG. 6) in the front end interface 33 is stored in the CPU core count field 71D.

In the present embodiment, it is assumed that the CPU cores 83A are equally assigned to the respective ports 81.

Therefore, for example, when the number of ports 81 is 2 and the number of CPU cores 83A is 8, the number of CPU cores per port is 4.

Therefore, in the case of the example of FIG. 10, it is indicated that the front end interface 33 of “FE0-A” is installed in the controller 32 of “CTRL0”, the number of ports 81 of the front end interface 33 is “2”, and the number of CPU cores 83A is “8”.

FIG. 11 shows a configuration of the session management table 72 stored in the memory 62 (FIG. 5) of the controller 32.

The session management table 72 is a table used by the controller 32 to manage a session established between the controller 32 and another storage system or the host server 27.

The controller 32 communicates with all the front end interfaces 33, and manages, in the session management table 72, the virtual session in which a plurality of real sessions established by the front end interface 33 are included, and a real session in a case in which only one real session is established by the front end interface 33, as respective sessions.

Since all the real sessions constituting one virtual session are established on the same remote path, local IP addresses, remote IP addresses, remote port numbers, target IQNs, use of session, and the authentication information of these real sessions are all the same.

As shown in FIG. 11, the session management table 72 includes a session ID field 72A, a local port ID field 72B, a local IP field 72C, a remote IP field 72D, a remote port number field 72E, a target IQN field 72F, a session state field 72G, a use of session field 72H, and an authentication information field 72I.

In the session management table 72, one record corresponds to one session (the real session or the virtual session).

An identifier (a session ID) unique to the corresponding session in the own-storage system 22 assigned to the session is stored in the session ID field 72A.

The port ID of the port 81 (FIG. 6) on the local side used by the session is stored in the local port ID field 72B, and the IP address set for the port 81 is stored in the local IP field 72C.

The IP address of the port 81 on the remote side used by the session is stored in the remote IP field 72D, and the port number of the storage system 24 on the remote side is stored in the remote port number field 72E.

Further, the IQN of the iSCSI target to which the session is connected is stored in the target IQN field 72F.

The state of the session (hereinafter, referred to as a session state) is stored in the session state field 72G.

Examples of the session state include “unconnected”, “TCP-connected”, “normal”, “during a failure”, and “during disconnect”, and the corresponding session state among these session states is stored in the session state field 72G.

When the corresponding session is a virtual session, a session state obtained by abstracting the states of the plurality of real sessions constituting the virtual session is stored in the session state field 72G.

Further, the us of the session is stored in the use of session field 72H.

The use includes “discovery” and “IO”, and the corresponding one of the two uses is stored in the use of session field 72H.

The “discovery” means a process in which an initiator communicates with a target in order to examine an IQN of the target, an IP address, a port number, or the like, and the “IO” means a process of reading and writing data.

Further, the authentication information used at the time of connection of the session is stored in the authentication information field 72I.

Therefore, in the case of the example of FIG. 11, it is indicated that the session having the session ID of “S1” is a session established between the port 81 on the local side for which the port ID of “P0-A0-1” and the IP address of “192.0.10.1” are set and the port 81 on the remote side for which the IP address of “192.0.100.1” of the storage system 24 having the port number of “3260” is set, the application thereof is the “IO”, the current session state is the “normal”, and the authentication information of the session is the “john@XXX”.

Further, FIG. 11 also shows that the IQN of the iSCSI target is “inq.2024-05.com.hatachi.iscsi: remote-1”.

On the other hand, FIG. 12 shows the virtual session management table 91 stored in the memory 84 (FIG. 6) of the front end interface 33 (FIG. 6).

The virtual session management table 91 is a table used by the CPU 83 of the front end interface 33 to manage a relation between real sessions established between the CPU 83 and another storage system 24 and a virtual session recognized by the controller 32 (to manage a plurality of real sessions as one virtual session).

The virtual session management table 91 includes a session ID field 91A, an use of virtual session field 91B, a real session ID field 91C, a CPU core number field 91D, a local port ID field 91E, a local IP field 91F, a local port number field 91G, a remote IP field 91H, a remote port number field 91I, a target IQN field 91J, and a session state field 91K.

In the virtual session management table 91, one row of each of the session ID field 91A, the use of virtual session field 91B, the local port ID field 91E, the local IP field 91F, the remote IP field 91H, the remote port number field 91I, and the target IQN field 91J corresponds to one virtual session, and one row of each of the real session ID field 91C, the CPU core number field 91D, the local port number field 91G, and the session state field 91K corresponds to one real session constituting the corresponding virtual session.

The session ID of the corresponding virtual session is stored in the session ID field 91A, and the use of the virtual session is stored in the use of session virtual field 91B.

Further, the real session ID field 91C is divided into a plurality of small fields corresponding to the respective real sessions constituting the corresponding virtual session, and the session IDs of the real sessions assigned to the respective corresponding real sessions are stored in the small fields.

Further, the CPU core number field 91D is also divided into a plurality of small fields corresponding to the respective real sessions constituting the corresponding virtual session, and the identifiers (CPU core numbers) of the CPU cores 83A (FIG. 6) assigned to the respective corresponding real sessions and responsible for the processes of the respective corresponding real sessions are stored in the small fields.

The port ID of the port 81 (FIG. 6) on the local side used by each of the respective real sessions constituting the corresponding virtual session is stored in the local port ID field 91E, and the IP address set for the port 81 is stored in the local IP field 91F.

Further, the local port number field 91G is divided into a plurality of small fields corresponding to the respective real sessions constituting the corresponding virtual session, and the port numbers of the ports 81 on the local side used by the respective corresponding real sessions are stored in the small fields.

Further, the IP addresses set for the ports 81 on the remote side to which the respective corresponding real sessions are connected are stored in the remote IP field 91H, and the port numbers of the ports 81 on the remote side to which the respective real sessions are connected are stored in the remote port number field 91I.

Further, the IQN of the iSCSI target to which the respective corresponding real sessions are connected is stored in the target IQN field 91J.

Further, the session state field 91K is divided into a plurality of small fields corresponding to the respective real sessions constituting the corresponding virtual session, and the session states of the respective corresponding real sessions are stored in the small fields.

Examples of the session state include the “unconnected”, the “TCP-connected”, the “normal”, the “during a failure”, and the “during disconnect”, and any of these session states is stored in the session state field 91K.

Therefore, in the case of the example of FIG. 12, it is indicated that the virtual session to which the session ID of “S1” is assigned has the use of “IO” and is obtained by virtualizing four real sessions of “S1-1”, “S1-2”, “S1-3”, and “S1-4”, and the processes of these real sessions are set to be performed by the CPU cores 83A to which the CPU core numbers “1”, “2”, “3”, and “4” are respectively assigned.

Further, it is indicated in FIG. 12 that on the local side, the real sessions use the ports 81 to which the port ID of “P0-A0-1” is assigned, the IP address of “192.0.30.1” is set, and the port numbers of “40001” to “40004” are assigned, and on the remote side, the real sessions use the port 81 to which the IP address “192.0.100.1” is set, and the port number “3260” is assigned.

Further, it is indicated in FIG. 12 that the IQN of the iSCSI target to which the real sessions are connected is “iqn.2024-05.com.hatachi.iSCSI: remote-1”, and the session states of these real sessions are currently the “normal”.

### (1-4) IO Command Format

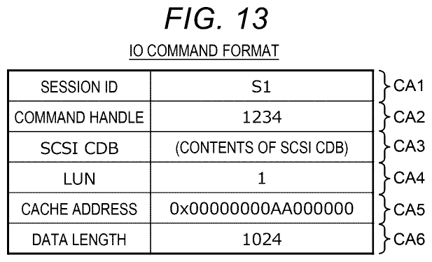

FIG. 13 shows an example of a command format of the IO command used in communication between the controller 32 and the front end interface 33 installed in the controller 32.

The IO command includes a session ID area CA1, a command handle area CA2, an SCSI CDB area CA3, a LUN area CA4, a cache address area CA5, and a data length area CA6.

A session ID of a virtual session to be a target of the IO command is stored in the session ID area CA1, and an identifier (a command handle) unique to the IO command is stored in the command handle area CA2.

The SCSI CDB area CA3 is a command descriptor block (CBD) in an SCSI protocol, and the content of the IO command is described in the SCSI CDB area CA3.

In addition, the LUN of the logical volume as an IO target is stored in the LUN area CA4, and a starting address of the storage area in the cache 63 (FIG. 5) in the controller 32, in which data as a read and write target is stored or is to be stored, is stored in the cache address area CA5.

Further, the data length of the data as the read and write target is stored in the data length area CA6.

After the session is established, the controller 32 transmits the IO command in the command format shown in FIG. 13 to the front end interface 33, and instructs the reading and writing of data from and to the storage system 24 as the remote replication destination.

Then, the front end interface 33 that has received the IO command dynamically determines the CPU core 83A to process the IO command, based on the command handle included in the IO command.

A specific method of determining the CPU core 83A at this time will be described later.

### (1-5) Flows of Various Kinds of Processing Related to Remote Replication

Next, flows of various kinds of processing executed in relation to the remote replication in an information processing system 1 according to the present embodiment described above will be described.

In the following description, a processing entity of a part of the above processing may be described as a “program”, but in practice, it will be appreciated that the CPU 61 (FIG. 5) of the controller 32 or the CPU core 83A (FIG. 6) of the front end interface 33 in the storage system 22 executes the processing based on the program.

### (1-5-1) Session Establishment Processing

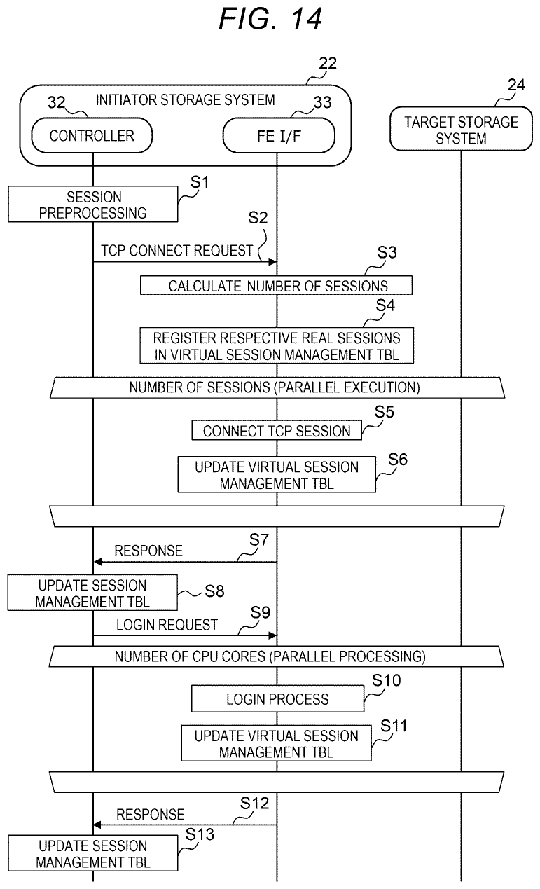

FIG. 14 illustrates a flow of a series of processes (hereinafter, referred to as session establishment processing) when the session is established between the initiator storage system 22 provided in the primary site 21 and the target storage system 24 provided in the secondary site 23.

The initiator storage system 22 establishes the iSCSI sessions with the target storage system 24 according to the flow of FIG. 14, and uses the iSCSI sessions in communication of the control information and the data for the remote replication.

Actually, in response to an instruction from the user, connection of the session with the target storage system 24 is started in the initiator storage system 22, and first, the following session preprocessing is executed (S1).

Specifically, the remote replication control program 67 (FIG. 5) of the controller 32 in the initiator storage system 22 instructs the session control program 65 (FIG. 5) to perform the session via each remote path that is set in advance by the user and is stored in the remote path management table 70 (FIG. 9).

The instruction includes information on a record corresponding to the remote path used by the session for which the connection is instructed by the user among the records in the remote path management table 70.

Then, the session control program 65 that has received the instruction stores the necessary information on the remote path used by the session for which the connection is instructed by the user, the information being included in the instruction, in the session management table 72 (FIG. 11) as the session information on the session to be connected at that time, and sets the session state of the session to the “unconnected”.

When the total number of sessions registered in the session management table 72 is equal to or larger than a predetermined threshold value set in advance at the factory, the session control program 65 interrupts a connect process of the session, responds to the remote replication control program 67 with an error, and ends the session establishment processing.

Subsequently, the session control program 65 transmits a TCP connect request to the front end interface 33 (S2).

The TCP connect request includes various information registered in the session management table 72 in relation to the corresponding session.

Then, the front end session control program 86 (FIG. 6) of the front end interface 33 that has received the TCP connect request calculates the number of sessions to be connected to the target storage system 24 (S3).

In the present embodiment, in the case of an IO session, the number of sessions per target storage system 24 is the number of CPU cores 83A assigned to the port 81 (FIG. 6), so that the load can be distributed among the CPU cores 83A.

As described above, in the case of the IO session, the CPU cores 83A are equally assigned to the ports 81.

In the case of a discovery session with a low processing load, the number of sessions per target is “1”.

Note that the number of sessions described above is merely an example, and the number of sessions may be changed according to a required performance or the use of the session.

Next, the front end session control program 86 of the front end interface 33 stores information on all real sessions to be newly connected at that time in the virtual session management table 91 (FIG. 12).

At this time, the states of the respective real sessions are set to the “unconnected” (S4).

At this time, when the number of virtual sessions registered in the virtual session management table 91 is equal to or larger than a threshold value set in advance at the factory, the front end session control program 86 interrupts the process, transmits an error to the session control program 65 of the controller 32, and then ends the session establishment processing.

Thereafter, the front end session control program 86 executes the processes of step S5 and step S6 in parallel with respect to the necessary real sessions, thereby performing TCP connect of these real sessions with the target storage system 24.

At this time, the front end session control program 86 assigns the respective CPU cores 83A to the real sessions.

Specifically, the front end session control program 86 transmits the TCP connect request to the target storage system 24 for the respective real sessions, thereby establishing the TCP connection with the target storage system 24 (S5).

At this time, the information included in the TCP connect request provided from the session control program 65 of the controller 32 in step S2 is used as connection information used for the TCP connect request, and the information is used for all the real sessions.

That is, the front end session control program 86 uses the information for all the real sessions.

Subsequently, the front end session control program 86 updates the information registered in the virtual session management table 91 related to the respective real sessions subjected to the TCP connection with the target storage system 24 in step S5 (S6).

Specifically, the front end session control program 86 changes the values in the session state field 91K (FIG. 12) corresponding to the respective real sessions in the virtual session management table 91 to the “TCP-connected”.

The front end session control program 86 stores the core number of the CPU core 83A assigned to the corresponding real session in the CPU core number field 91D (FIG. 12) corresponding to the real sessions in the virtual session management table 91.

The front end session control program 86 executes the series of processes of step S5 and step S6 described above in parallel by the number of the real sessions obtained in step S3.

Accordingly, it is possible to restrain an increase in a processing time of TCP connect processing due to an increase in the number of sessions.

When the process of step S5 fails even for one real session, the front end session control program 86 interrupts the TCP connect processing of all the real sessions, transmits an error to the session control program 65 of the controller 32, and then ends the session establishment processing.

This is because the real sessions share a physical path, when the TCP connect fails for one real session, it can be determined that the same state occurs for other real sessions.

On the other hand, when the front end session control program 86 completes the TCP connect of these real sessions with the target storage system 24 by completing the execution of the processes of step S5 and step S6 for all the real sessions, the front end session control program 86 transmits a response to the session control program 65 of the controller 32 (S7).

Then, the session control program 65 of the controller 32 that has received the response updates the session state of the corresponding virtual session in the session management table 72 (FIG. 11) to the “TCP-connected” (S8).

Further, the session control program 65 transmits, to the front end interface 33 as a transmission source of the response received in step S7, a login request for requesting login to the virtual session whose state is updated in step S8 (S9).

The login request includes all contents of records corresponding to the virtual session in the session management table 72.

Then, regarding the respective real sessions constituting the virtual session, the front end session control program 86 of the front end interface 33 that has received the login request causes the CPU cores 83A assigned to the respective real sessions to execute the processes of step S10 and step S11 in parallel, thereby performing login to the real sessions.

Actually, the front end session control program 86 transmits an iSCSI login request for each CPU core 83A assigned to the corresponding real session in step S5 to the target storage system 24.

Accordingly, the iSCSI session login for each real session is performed.

At this time, the front end session control program 86 uses the information received from the session control program 65 of the controller 32 in step S9 for all the real sessions as connection information used for the iSCSI login request.

The front end session control program 86 updates the virtual session management table 91 such that the states of the respective real sessions are the “normal” (S11).

Then, when the front end session control program 86 completes the processes of step S10 and step S11 described above for all the real sessions, the front end session control program 86 ends an iSCSI login process for the respective real sessions.

At this time, when the iSCSI login process of step S10 fails even for one real session, the front end session control program 86 interrupts the iSCSI login process for all the real sessions, transmits an error to the session control program 65 of the controller 32, and then ends the session establishment processing.

Thereafter, the front end session control program 86 responds to the session control program 65 of the controller 32 that the login to the virtual session for which the login is requested in step S9 is completed (S12).

Then, when receiving the response, the session control program 65 updates the session management table 72 (S13).

Specifically, the session control program 65 updates the value stored in the session state field 72G (FIG. 11) of the record corresponding to the virtual session in the session management table 72 to the “normal”.

Accordingly, the session establishment processing ends.

Further, by such session establishment processing, a different real session is established for each CPU core 83A at the time of IO session in the front end interface 33.

Accordingly, load distribution between the CPU cores 83A in a subsequent IO process is achieved.

### (1-5-2) Write IO Command Processing

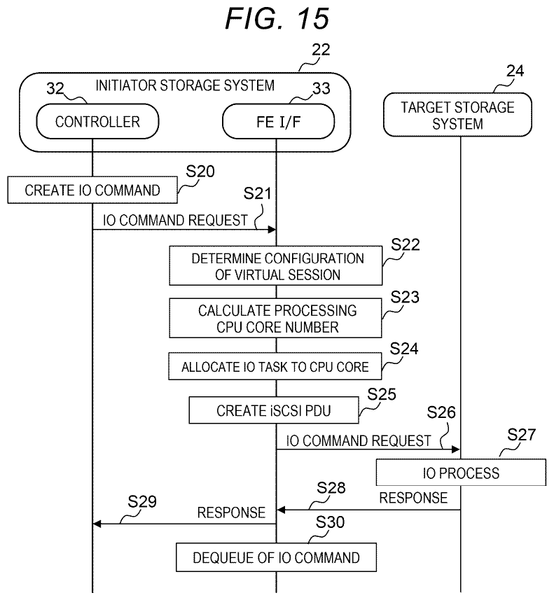

FIG. 15 illustrates a flow of a series of processes (hereinafter, referred to as write IO command processing) when the initiator storage system 22 performs the remote replication to the target storage system 24.

When executing the remote replication, the remote replication control program 67 of the controller 32 issues an IO command for reading and writing control information and replicated data from and to the target storage system 24 to the session control program 65.

Then, the session control program 65 creates a write IO command according to the IO command (S20).

At this time, the session control program 65 uses, as a handle value of the write IO command, a value obtained by using any hash function and recalculating the starting address on the cache 63 (FIG. 5) in which the write IO command is stored.

Accordingly, it is possible to prevent a bias from occurring when calculating the CPU core 83A responsible for processing the write IO command based on the handle value as described below.

The hash function here means a function that calculates any data by using a certain procedure and outputs a random fixed-length character string (a hash value).

However, as a method of calculating the handle value of the write IO command, various other methods can be widely applied.

For example, a random number may be used as the handle value.

Further, a value other than a numeric value may be used as the handle value (command handle information) of the command.

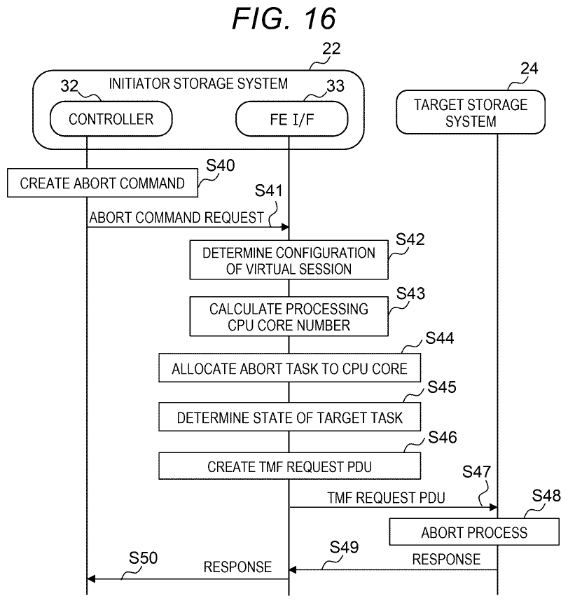

In addition, the session control program 65 stores the handle value of the created write IO command and uses the handle value in abort command processing to be described later with reference to FIG. 16.

Referring back to FIG. 15, when the session control program 65 of the controller 32 creates the write IO command in step S20, the session control program 65 transmits the write IO command and data as a write target (hereinafter, referred to as write data) to the front end interface 33 (S21).

The front end session control program 86 of the front end interface 33 that has received the write IO command and the write data determines whether the write IO command is directed to a virtual session including a plurality of real sessions (S22).

Then, when the front end session control program 86 confirms that the write IO command is directed to the virtual session including a plurality of real sessions, the front end session control program 86 calculates a core number of a CPU core 83A (hereinafter, referred to as a processing CPU core number) that processes the write IO command by the following equation (S23).

$$\begin{matrix}[ Math . 1 ] & \\ “ the processing CPU core number ” = “ the handle value ” \% “ the number of CPU cores assigned to the port ” + “ the CPU core number offset of the port ” & ( 1 )\end{matrix}$$

That is, the front end session control program 86 calculates, as the processing CPU core number, a value obtained by adding a CPU core number offset of the corresponding port 81 to a remainder (a surplus) obtained by dividing the handle value of the write IO command by the number of CPU cores 83A assigned to the port 81.

Here, the “corresponding port” means the port 81 in the own-front end interface 33 that is session-connected to the target storage system 24 to which data is written by the write IO command.

Here, the “CPU core number offset” means the CPU core number of the leading CPU core 83A among the plurality of CPU cores 83A assigned to each port 81.

In the present embodiment, the CPU cores 83A having consecutive CPU core numbers are equally assigned to the ports 81.

For example, when the number of ports 81 is 2 and the number of CPU cores 83A is 8, 4 CPU cores 83A having the CPU core numbers “0” to “3” are assigned to the first port 81, and 4 CPU cores 83A having the CPU core numbers “4” to “7” are assigned to the second port 81.

Therefore, in the case of this example, the “CPU core number offset” is “0” for the first port 81, and is “4” for the second port 81.

When the write IO command from the controller 32 is not directed to the virtual session including a plurality of real sessions in step S22 (that is, the virtual session includes only one real session), the front end session control program 86 determines the CPU core number of the CPU core 83A responsible for the real session as the processing CPU core number.

Subsequently, the front end session control program 86 enqueues the write IO command acquired in step S21 in an IO command queue to be managed by the CPU core 83A having the processing CPU core number calculated in step S23 (S24).

As a result, the CPU core 83A executes the iSCSI initiator program 90 (FIG. 6) and transmits the write IO command to the target storage system 24 (S25, S26).

Specifically, the iSCSI initiator program 90 being executed by the CPU core 83A creates an iSCSI_PDU (Protocol Data Unit) of the write IO command (S25).

Here, the “iSCSI_PDU” is an information unit in which the above write IO command for accessing the target storage system 24 is encapsulated.

Then, the iSCSI initiator program 90 transmits the created iSCSI_PDU and the write data to the target storage system 24 (S26).

On the other hand, when receiving the iSCSI_PDU and the write data, the target storage system 24 executes the IO process (a write process) for storing the write data in the corresponding logical device in the corresponding logical volume according to the write IO command included in the iSCSI_PDU (S27). When the IO process is completed, the target storage system 24 transmits a response to that effect to the front end interface 33 as a transmission source of the iSCSI_PDU in the initiator storage system 22 (S28).

Then, the iSCSI initiator program 90 being executed by the corresponding CPU core 83A of the front end interface 33 that has received the response responds to the own-controller 32 that the writing of data is completed (S29).

Further, the iSCSI initiator program 90 dequeues the above write IO command from the corresponding IO command queue (S30), and then ends the series of processes.

Although the case in which the IO command transmitted from the controller 32 to the front end interface 33 is a write IO command has been described, a case in which the IO command is a read IO command for reading data from the target storage system 24 is executed in the same manner.

Further, the processes of step S22 to step S26 in FIG. 15 are executed each time an IO command request is provided from the controller 32 to the front end interface 33.

Accordingly, in the present embodiment, the front end interface 33 can distribute the load of the IO command from the controller 32 between the real sessions, thereby distributing the load between the CPU cores 83A.

Further, according to the present embodiment, in the front end interface 33, since the CPU core 83A that processes the IO command from the controller 32 is dynamically calculated based on the content of the IO command, the load distribution between the CPU cores 83A can be achieved with less processing overhead.

### (1-5-3) Abort Command Processing

FIG. 16 illustrates a flow of a series of processes (hereinafter, referred to as abort command processing) when the initiator storage system 22 causes the target storage system 24 to interrupt the execution of the issued IO command.

By issuing an abort command to the target storage system 24, the initiator storage system 22 can cause the target storage system 24 to interrupt the execution of the issued IO command.

Actually, when a timeout of the IO command processing or an abort instruction from the remote replication control program 67 (FIG. 5) is provided, the controller 32 of the initiator storage system 22 starts the abort command processing on the issued IO command, and first creates the abort command (S40).

The abort command created at this time includes the session ID of the virtual session to be used by the IO command as an abort target and the handle value of the IO command as the abort target.

Then, the controller 32 transmits the created abort command to the front end interface 33 that has issued the IO command as the abort target (S41).

The front end session control program 86 of the front end interface 33 that has received the abort command refers to the virtual session management table 91 and determines whether the virtual session connected to the target storage system 24, which is a transmission destination of the IO command as the abort target, includes a plurality of real sessions (S42).

Then, when a positive result is acquired in the determination, the front end session control program 86 determines the CPU core number (the processing CPU core number) of the CPU core 83A to process the abort command by the following equation (S43).

$$\begin{matrix}[ Math . 2 ] & \\ “ the processing CPU core number ” = “ the handle value of the command as the abort target ” \% “ the number of CPU cores assigned to the port ” + “ the CPU core number offset of the port ” & ( 2 )\end{matrix}$$

That is, the front end session control program 86 calculates, as the processing CPU core number, a value obtained by adding the CPU core number offset of the port 81 that has issued the IO command, to a remainder (a surplus) obtained by dividing the handle value of the IO command as the abort target included in the abort command by the number of CPU cores 83A assigned to the port 81.

Accordingly, the CPU core number of the CPU core 83A that has processed the command as the abort target is calculated as the CPU core number of the CPU core 83A to process the abort command.

On the other hand, when the virtual session connected to the target storage system 24, which is the transmission destination of the IO command as the abort target, is constituted by a single real session, the front end session control program 86 determines the CPU core number of the CPU core 83A to process the abort command, as the CPU core number of the CPU core 83A responsible for the real session.

This is because when there is only one real session, there is only one CPU core assigned to the virtual session, and it is not necessary to distinguish the CPU core according to a command type.

Subsequently, the front end session control program 86 transfers the abort command to the iSCSI initiator program (hereinafter, referred to as an assigned iSCSI initiator program) 90 being executed by the CPU core 83A to which the CPU core number calculated in step S43 is assigned (S44).

Then, the assigned iSCSI initiator program 90 first searches the command queue of the CPU core 83A executing the assigned iSCSI initiator program 90, and determines a processing state of the IO command as the abort target (S45).

Then, when the IO command as the abort target is being processed and has been transmitted to the target storage system 24, the assigned iSCSI initiator program 90 proceeds to step S46.

When the IO command as the abort target is being processed and has not been transmitted to the target storage system 24, the assigned iSCSI initiator program 90 proceeds to step S50 after interrupting the processing of the IO command, and responds to the controller 32 that the abort is successful.

Further, when the processing of the IO command as the abort target is completed in the target storage system 24, the assigned iSCSI initiator program 90 proceeds to step S50 and responds to the controller 32 that the abort is unsuccessful.

On the other hand, when proceeding to step S46, the assigned iSCSI initiator program 90 creates a task management function (TMF) Request PDU for aborting the IO command as the abort target (S46), and transmits the created TMF Request PDU to the target storage system 24 (S47).

Here, the “TMF Request” means a command request for managing a task in the iSCSI protocol.

Then, the target storage system 24 that has received the TMF Request PDU aborts the IO command as the abort target when the IO command as the abort target can be aborted (S48), and responds to the initiator storage system 22 with a result of the abort (S49).

Then, the assigned iSCSI initiator program 90 of the initiator storage system 22 that has received the response responds to the own-controller 32 with the success or failure of the abort (S50).

Accordingly, the abort command processing ends.

As described above, in the present embodiment, since the CPU core 83A responsible for the processing of the real session to be used by the IO command is specified based on the handle value of the IO command as the abort target, it is possible to specify the real session as an abort target in the front end interface 33 and abort the IO command as the abort target even when the virtual session includes a plurality of real sessions.

### (1-5-4) Session Disconnect Processing

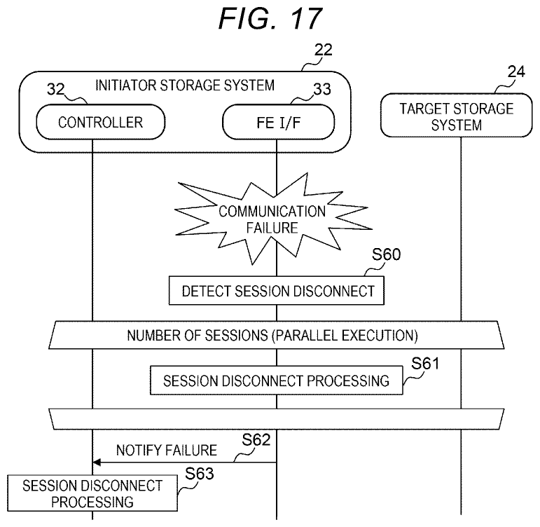

FIG. 17 illustrates a flow of a series of processes (hereinafter, referred to as the session disconnect processing) to be executed in the initiator storage system 22 in order to disconnect the session with the target storage system 24 when a communication failure occurs between the front end interface 33 of the initiator storage system 22 and the target storage system 24.

As will be described later, in a case in which even one real session among a plurality of real sessions constituting the same virtual session established between the front end interface 33 of the initiator storage system 22 and the target storage system 24 is disconnected, the front end interface 33 disconnects all the remaining real sessions established between the front end interface 33 and the target storage system 24.

This is because all of these real sessions communicate by using the same IP address and thus share a physical communication path.

Therefore, when the communication failure is detected by one real session, it can be determined that the communication failure also occurs in the remaining other real sessions.

Here, the communication failure means a failure in which communication with the target storage system 24 becomes impossible due to a device failure such as the ports 81 (FIG. 6) of the front end interface 33 and a switch on a network path.

Then, when detecting such a communication failure, the iSCSI initiator program 90 being executed by the CPU core 83A notifies the front end session control program 86 that the failure occurs in the real session (S60).

Here, as a method of detecting such a communication failure, monitoring of hardware failure information by the iSCSI initiator program 90 and forced disconnect reception from the target storage system 24 are assumed.

The front end session control program 86 that has received the notification executes the session disconnect processing for disconnecting the real session in which the communication failure is detected by the iSCSI initiator program 90 and all other real sessions constituting the same virtual session as the real session in parallel (S61).

Specifically, the front end session control program 86 instructs the iSCSI initiator programs 90 to be executed by the CPU cores 83A responsible for the processing of the real sessions constituting the virtual session to disconnect the real sessions.

Thus, each iSCSI initiator program 90 that has received this instruction forcibly disconnects the session with the corresponding target storage system 24, and releases session-related resources in the front end interface 33.

By performing the disconnect processing of the plurality of real sessions in parallel in this manner, it is possible to restrain an increase in a session disconnect time associated with an increase in the number of sessions.

Then, when the disconnect of all the corresponding real sessions is completed, the front end session control program 86 notifies the own-controller 32 of the disconnect of the virtual session configured with the real sessions (S62).

In addition, the session control program 65 (FIG. 5) of the own-controller 32 that has received the notification updates the value stored in the session state field 72G of the record corresponding to the virtual session in the session management table 72 (FIG. 11) to the “during a failure”, and releases all releasable resources related to the virtual session.

Accordingly, the session disconnect processing ends.

### (1-5-5) Session Monitoring Processing

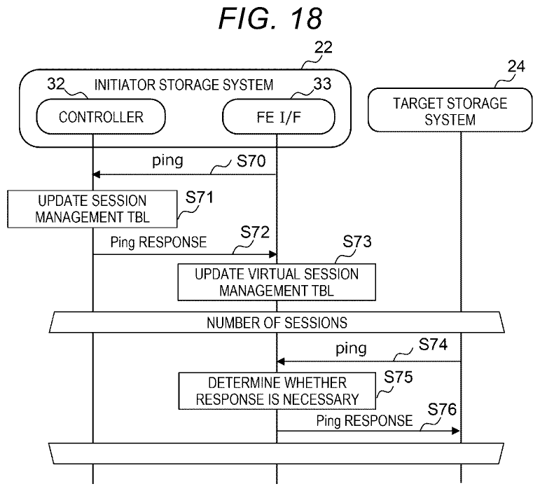

FIG. 18 illustrates a flow of session monitoring processing to be executed between the initiator storage system 22 and the target storage system 24.

The front end interface 33 of the initiator storage system 22 monitors an alive or dead state of the own-controller 32 by a ping (an alive monitoring notification).

In addition, the front end interface 33 responds to a ping, which is provided from the target storage system 24 in order to perform alive monitoring on the respective real sessions, only when the own-controller 32 is in a normal state, and does not respond when there is no response to the ping from the own-controller 32.

Accordingly, in the information processing system 1, the target storage system 24 can receive a ping response from the initiator storage system 22 only when the initiator storage system 22 can normally communicate with the target storage system 24 while including the state of the controller 32.

Here, the “ping” means communication for confirming network communication, and a character string is transmitted to a designated destination to confirm network connection by the presence or absence of a response to the character string.

The same applies to the following description.

Specifically, the front end session control program 86 of the front end interface 33 periodically issues the ping for performing the alive monitoring to the own-controller 32 (S70).

Then, the session control program 65 of the controller 32 that has received the ping updates the state of the session offloaded to the front end interface 33 in the session management table 72 to the “normal” (updates the value stored in the corresponding session state field 72G in the session management table 72 to the “normal”) (S71), and then transmits a ping response to the front end interface 33 (S72).

Further, the front end session control program 86 of the front end interface 33 that has received the response updates the states of the real sessions constituting each virtual session managed in the virtual session management table 91 (FIG. 12) to the “normal” (updates the values stored in the session state field 91K in the virtual session management table 91 to the “normal”) (S73).

When the front end session control program 86 cannot receive a ping response from the own-controller 32 even after a certain period of time has elapsed after transmitting the ping to the own-controller 32 in step S70, the front end session control program 86 updates the states of the real sessions constituting each virtual session managed in the virtual session management table 91 to the “during a failure”.

On the other hand, the target storage system 24 also periodically transmits the ping for performing the alive monitoring for each real session established between the target storage system 24 and the initiator storage system 22 (S74).

Then, the front end interface 33 of the initiator storage system 22 that has received the ping determines whether the response to the ping is necessary (S75).

Specifically, in the front end interface 33, the iSCSI initiator program 90 (FIG. 6) executed by the CPU core 83A assigned to each of the real sessions notifies the front end session control program 86 that the ping from the target storage system 24 is received.

In addition, when receiving the notification, the front end session control program 86 refers to the virtual session management table 91 and determines whether the states of all the corresponding real sessions with the initiator storage system 22 are the “normal”.

Then, the front end session control program 86 does not transmit the ping response to the target storage system 24 when a negative result is acquired in the determination, and transmits the ping response to the target storage system 24 only when a positive result is acquired in the determination (S76).

The front end session control program 86 executes such a process of step S76 for all the real sessions.

As described above, the alive monitoring of the initiator storage system 22 by the target storage system 24 is completed, and thereafter, the processes of step S70 and subsequent steps are periodically repeated.

### (1-6) Effects of Present Embodiment

As described above, in the information processing system 1 according to the present embodiment, in the front end interface 33 of the initiator storage system 22, the plurality of real sessions are connected to the target storage system 24, and the different CPU cores 83A are assigned to the respective real sessions.

Then, in the front end interface 33, the IO command provided from the controller 32 is equally assigned to the CPU cores 83A respectively assigned to the plurality of real sessions and is processed.

Therefore, since the IO command provided from the controller 32 to the front end interface 33 can be processed by the plurality of CPU cores 83A, the load onto the CPU cores 83A can be distributed, and the performance of a single CPU core 83A can be prevented from becoming a bottleneck in communication performance.

Further, in the information processing system 1, the controller 32 manages the plurality of real sessions as one virtual session.

Therefore, the number of pieces of session information to be managed by the controller 32 using the session management table 72 (FIG. 11) stored in the memory 62 (FIG. 5) can be restrained as in the related art, and the consumption of the memory 62 can be restrained.

Therefore, according to the information processing system 1 of the present embodiment, it is possible to improve the communication performance while restraining the consumption of the memory 62 of the controller 32.

### (2) Second Embodiment

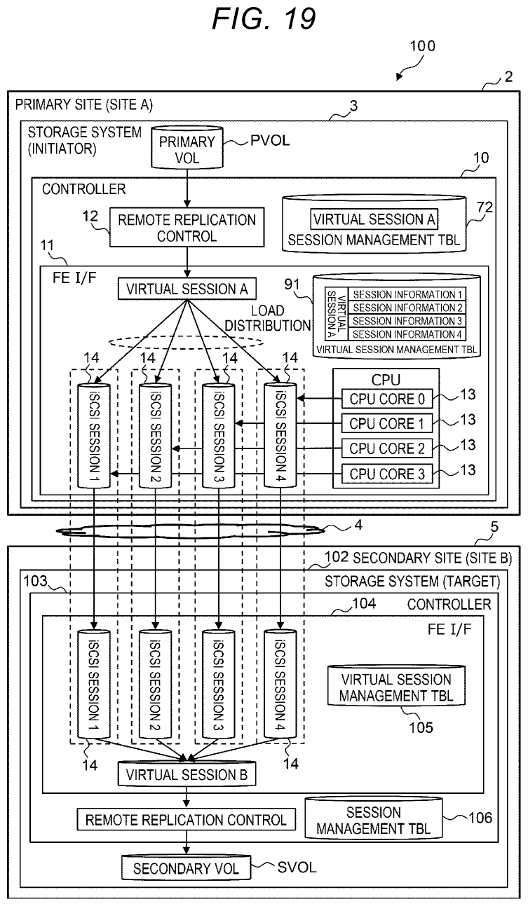

FIG. 19, in which parts corresponding to those in FIG. 1 are denoted by the same reference numerals, illustrates an outline of an information processing system 100 according to a second embodiment.

The present embodiment is the same as the first embodiment in that the remote replication is performed from the storage system (the initiator storage system) 3 of the primary site 2 to a storage system (a target storage system) 102 of the secondary site 5 via the network 4.

However, in the present embodiment, one or more front end interfaces 104 are also installed in a controller 103 of the target storage system 102 in the secondary site 5, and the present embodiment is different from the first embodiment in that communication for the remote replication is offloaded from the controller 103 to the front end interface 104 as in the initiator storage system 3 (the storage system 22 in FIG. 2) according to the first embodiment.

Further, in the present embodiment, when the front end interface 104 of the target storage system 102 receives an establishment request of a plurality of real sessions 14 for the remote replication from the initiator storage system 3 (the storage system 22 in FIG. 2), the plurality of established real sessions 14 are presented to the controller 103 as one virtual session.

More specifically, the front end interface 104 of the target storage system 102 registers and manages the plurality of real sessions 14 in a virtual session management table 105, and the virtual session management table 105 is managed in the front end interface 104 and has the same configuration as the virtual session management table 91 described above with reference to FIG. 12.

In addition, the controller 103 in which the front end interface 104 is installed manages a virtual session including the real sessions 14 as one session by using a session management table 106, and the session management table 106 has the same configuration as the session management table 72 described above with reference to FIG. 11.

Accordingly, it is possible to reduce the number of sessions to be managed by the controller 103 of the target storage system 102 using the session management table 106.

Further, according to this method, it is possible to establish more real sessions 14 between the initiator storage system 3 and the target storage system 102 without increasing the resource consumption of the controller 103 of the target storage system 102.

Therefore, according to the present embodiment, the communication performance of the target storage system 102 can also be improved while restraining the memory consumption of the controller 103.

In the target storage system 102 according to the present embodiment, a hardware structure, configurations of stored various management tables, and the flows of various processes are all the same as those of the initiator storage system 3 (the storage system 22 in FIG. 2) according to the first embodiment, and thus the description thereof will be omitted.

### (3) Third Embodiment

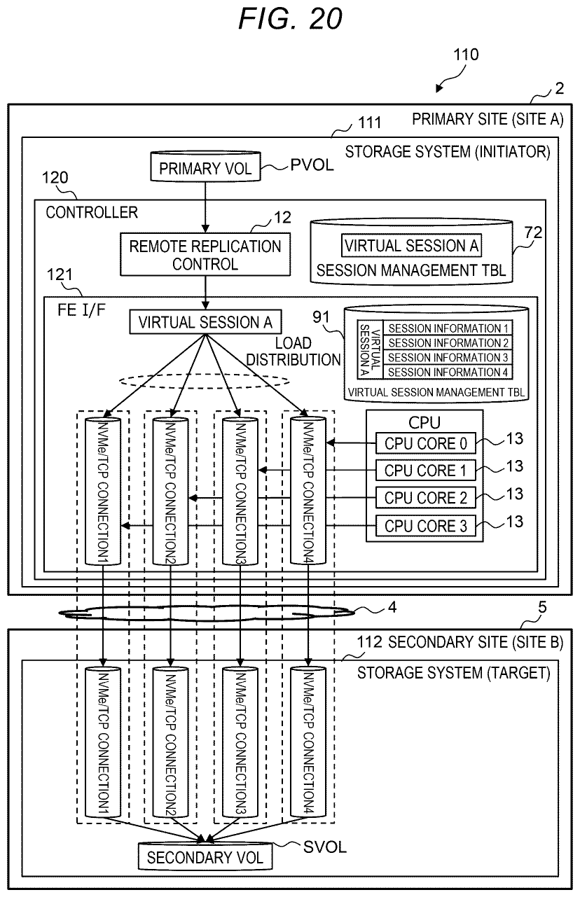

FIG. 20, in which parts corresponding to those in FIG. 1 are denoted by the same reference numerals, illustrates an outline of an information processing system 110 according to a third embodiment.

The present embodiment is the same as the first embodiment in that the remote replication is performed from a storage system (an initiator storage system) 111 of the primary site 2 to a storage system (a target storage system) 112 of the secondary site 5 via the network 4.

However, the present embodiment is different from the first embodiment in that, in the initiator storage system 111, a front end interface 121 converts a session request or an IO command from a controller 120 into a multiple-core compatible protocol such as a non-volatile memory express (NVMe)/TCP protocol and transmits the protocol to the target storage system 112.

According to the NVMe/TCP protocol, load distribution between a plurality of cores is possible by connecting a plurality of TCP/IP connections in one session between an initiator and a target and configuring an independent queue for each connection.

Therefore, even when one session is used, the same number of connections as the number of CPU cores can be created, and thus the load distribution between the CPU cores in the front end interface 121 can be performed.

In the present embodiment, the front end interface 121 of the initiator storage system 111 presents a plurality of NVMe/TCP sessions with the initiator storage system 111 to the controller 120 as virtual sessions.

Accordingly, it is possible to perform NVMe/TCP communication for the remote replication with the resource consumption amount of the controller 120 equivalent to that in the related art.

In addition, the load can be distributed between the CPU cores 13 in the front end interface 121 of the initiator storage system 111, and the communication performance can be improved.

Therefore, according to the information processing system 110 of the present embodiment, similarly to the information processing system 1 of the first embodiment, it is possible to improve the communication performance while restraining the memory consumption of the controller 120 of the initiator storage system 111.

In the initiator storage system 111 according to the present embodiment, a hardware structure, configurations of stored various management tables, and the flows of various processes are all the same as those of the initiator storage system 3 (the storage system 22 in FIG. 2) according to the first embodiment except that the communication protocol with the target storage system 112 is changed to the NVMe/TCP protocol, and thus the description thereof will be omitted.

### (4) Other Embodiments

In the first embodiment to the third embodiment described above, the case in which the smart NICs are applied as the front end interfaces 11, 33, 104, and 121 of the storage systems 3, 22, 24, 102, 110, and 111 has been described, but the present invention is not limited thereto, and for example, the present invention can also be applied to a storage system in which a controller performs communication processing without using a smart NIC.

Further, in the first embodiment to the third embodiment described above, the case has been described in which the iSCSI protocol or the NVMe/TCP protocol is applied as the communication protocol between the host server 27 and the storage systems 3, 22, 24, 102, 110, and 111, but the present invention is not limited thereto, and for example, a communication protocol such as fibre channel (FC)-SCSI or FC-NVMe may be applied.

In addition, in the first embodiment to the third embodiment described above, the case has been described in which a connection destination to which a storage node connects a plurality of real sessions is a target storage system and these real sessions are used for the remote replication, but the present invention is not limited thereto, and the present invention can also be applied to a case in which such a real session is used as a session for processing a command involving any communication other than the remote replication and a communication destination is any target node other than the storage system.

The present invention is not limited to the first embodiment to the third embodiment described above and other embodiments described above, and includes various modifications.

For example, the first embodiment to the third embodiment described above have been described in detail to facilitate understanding of the present invention, and the present invention is not necessarily limited to those including all the configurations described above.

In addition, a part of a configuration according to a certain embodiment can be replaced with a configuration according to another embodiment, and a configuration according to another embodiment can be added to a configuration according to a certain embodiment.

In addition, another configuration can be added to, deleted from, or replaced with a part of a configuration of each embodiment.

Further, some or all of the configurations, functions, processing units, and the like in the first embodiment to the third embodiment may be implemented by hardware by, for example, designing with an integrated circuit.

In addition, the configurations, functions, or the like may be implemented by software by a processor executing a program for implementing each function.

Information such as a program, a table, and a file for implementing each function can also be stored in a recording device such as a memory, a hard disk device, and an SSD, or in a recording medium such as an integrated circuit (IC) card and an SD card.

Further, control lines and information lines are those considered to be necessary for description, and not all control lines and information lines are necessarily shown in the product.

Actually, it may be considered that almost all the configurations are connected to one another.

### INDUSTRIAL APPLICABILITY

The present invention can be applied to a storage system in which a controller offloads communication processing to a network interface.

What is claimed is:

1. A storage system having a node and providing a storage area for storing data in a host device, the storage system comprising:
a network interface provided with a processor having a plurality of cores, each core processing a command involving communication with a target outside the node; and
a controller configured to control reading and writing of the data, issue the command involving the communication with the target, and cause the network interface to process the command, the network interface and the controller being provided at the node, wherein
the network interface
connects a plurality of first sessions between the network interface and the target, and assigns the respective cores of the processor to the first sessions,
manages the plurality of first sessions between the network interface and the target as one virtual second session, and
processes the command involving the communication with the target, which is issued from the controller, by using the second session using any one of the plurality of first sessions.

2. The storage system according to claim 1, wherein
the controller transmits, to the network interface, a connection request for the second session including information on a remote path set between the network interface and the target, and
the network interface connects each of the plurality of first sessions between the network interface and the target based on the information on the remote path included in the connection request.

3. The storage system according to claim 1, wherein
the network interface determines the number of the first sessions to be connected to the target, according to the number of cores of the processor and a use of the session.

4. The storage system according to claim 1, wherein
the core is associated with a port used for communication,
the command includes a command handle value,
the command handle value is associated with the port, and
the network interface uses the command handle value included in the command to determine a core using the port associated with the command handle value as the core to which the processing of the command is assigned.

5. The storage system according to claim 4, wherein
the controller
stores the command handle value included in the issued command to the network interface, and
when issuing, to the network interface, an abort request to abort the command, causes the command handle value in the command to be included in the abort request, and
the network interface determines the core responsible for the abort request based on the command handle value in the command serving as an abort target included in the abort request.

6. The storage system according to claim 1, wherein
the network interface performs alive monitoring on the controller and responds to an alive monitoring notification from the target.

7. A control method of a storage system having a node and providing a storage area for storing data in a host device, the storage system including, at the node,
a network interface provided with a processor having a plurality of cores, each core processing a command involving communication with a target outside the node, and
a controller configured to control reading and writing of the data, issue the command involving the communication with the target, and cause the network interface to process the command,
the control method comprising:
a first step of the network interface connecting a plurality of first sessions between the network interface and the target, allocating the respective cores of the processor to the first sessions, and managing the plurality of first sessions between the network interface and the target as one virtual second session; and
a second step of the network interface processing the command involving the communication with the target, which is issued from the controller, by using the second session using any one of the plurality of first sessions.

8. The control method of the storage system according to claim 7, wherein
in the first step,
the controller transmits, to the network interface, a connection request for the second session including information on a remote path set between the network interface and the target, and
the network interface connects each of the plurality of first sessions between the network interface and the target based on the information on the remote path included in the connection request.

9. The control method of the storage system according to claim 7, wherein
in the first step, the network interface determines the number of the first sessions to be connected to the target, according to the number of cores of the processor and use of a session.

10. The control method of the storage system according to claim 7, wherein
the core is associated with a port used for communication,
the command includes a command handle value,
the command handle value is associated with the port, and
in the second step, the network interface uses the command handle value included in the command to determine a core using the port associated with the command handle value as the core to which the processing of the command is assigned.

11. The control method of the storage system according to claim 10, wherein
the controller
stores the command handle value included in the issued command to the network interface, and
when issuing, to the network interface, an abort request to abort the command, causes the command handle value in the command to be included in the abort request, and
the network interface determines the core responsible for the abort request based on the command handle value in the command serving as an abort target included in the abort request.

12. The control method of the storage system according to claim 7, wherein
the network interface performs alive monitoring on the controller and responds to an alive monitoring notification from the target.
